(19) United States
(12) Patent Application Publication
(10) Pub. No.: US 2025/0327558 A1
(43) Pub. Date: Oct. 23, 2025

(54) OPTICAL DEVICE WITH FLOWING EFFECT

(71) Applicant: LONVIS TECHNOLOGY (SHENZHEN) CO., LTD., Shenzhen (CN)

(72) Inventor: Xuequan LI, Shenzhen (CN)

(73) Assignee: LONVIS TECHNOLOGY (SHENZHEN) CO., LTD., Shenzhen (CN)

(21) Appl. No.: 18/896,489

(22) Filed: Sep. 25, 2024

(30) Foreign Application Priority Data
Apr. 19, 2024 (CN) 202420834414.3

(51) Int. Cl. F21V 3/00; F21V 5/00

(52) U.S. Cl. CPC F21V 3/00; F21V 5/00

(57) ABSTRACT

An optical device with a flowing effect includes: a light bead; a first cover body, having a first internal space, wherein the light bead is located in the first internal space; a second cover body, located outside the first cover body, wherein lines are provided on surfaces of both the first cover body and the second cover body; a driving mechanism, wherein the first cover body and the second cover body undergo relative motion under the driving of the driving mechanism; and a stand body, wherein the light bead and the driving mechanism are both fixed on the stand body. In the present disclosure, with the relative motion between the two lamp covers, an optical path will move to change all the time. The optical path distorts and/or deforms after passing through the first cover body, and will distort and/or deform again when passing through the second cover body.

### CROSS-REFERENCE TO RELATED APPLICATIONS

This application claims priority to Chinese Patent Application No. 202420834414.3, filed on Apr. 19, 2024, the content of which is incorporated herein by reference in its entirety.

### TECHNICAL FIELD

The present disclosure relates to the technical field of optical equipment, and in particular, to an optical device with a flowing effect.

### BACKGROUND

In modern life, in order to adapt to different environmental occasions such as indoor, outdoor, landscapes, amusement parks, or exhibitions, people usually use various types of lamps or optical devices for decoration and projection to create appropriate scene atmospheres and create lighting effects that can make people quickly immerse in a current environmental atmosphere. For example, light with a water ripple projection effect can be applied to presentation of interior decoration, illumination of an outer wall of a building, aquarium projection, and garden landscape projection.

At present, various types of projection lamps are constantly emerging on the market. Most of the existing projection lamps with flowing effects are of a combined structure of a light-emitting diode (LED) light source, a condensing lens, a water ripple plate, and a camera. The lens is fixed, but the water ripple plate rotates, thereby forming a dynamic pattern that is projected onto a wall. However, the rotation of the water ripple plate in front of the LED light source can form a marginal shadow in a flowing direction of water ripples projected onto the wall, which affects the lighting effect. Most of the existing lamps with the flowing and projection effects have complex structures. The projected lighting effect has a single flowing direction, causing the problem of poor viewing effect. Therefore, this needs to be improved.

### SUMMARY

In view of the shortcomings in the prior art, the present disclosure provides an optical device with a flowing effect, so that an optical path can be completely dispersed under the superposition and cooperation of two optical path distortions and/or deformations and a relative motion, and projected light shadows have a flowing effect.

Technical solutions in the present disclosure are implemented as follows.

An optical device with a flowing effect includes: a light bead; a first cover body, having a first internal space, wherein the light bead is located in the first internal space; a second cover body, located outside the first cover body, wherein textures are provided on surfaces of both the first cover body and the second cover body; a driving mechanism wherein the first cover body and the second cover body undergo relative motion under the driving of the driving mechanism; and a stand body, wherein the light bead and the driving mechanism are both fixed on the stand body.

Preferably, the first cover body is in any of a cylindrical shape, a columnar shape, an olive shape, a drum shape, a cone shape, a step shape, and a spherical shape.

Preferably, the relative motion is axial relative motion.

Preferably, the driving mechanism is connected to the first cover body and is configured to drive the first cover body to perform rotation motion by using an axial horizontal line as a rotation axis.

Preferably, the driving mechanism is connected to the second cover body and is configured to drive the second cover body to perform rotation motion by using a vertical line, where a center line of the second cover body is located, as a rotation axis.

Preferably, the driving mechanism includes a first driving structure and a second driving structure; the first driving structure is connected to the first cover body and is configured to drive the first cover body to perform rotation motion by using an axial horizontal line as a rotation axis; and the second driving structure is connected to the second cover body and is configured to drive the second cover body to perform rotation motion by using a vertical line, where a center line of the second cover body is located, as a rotation axis.

Preferably, the second cover body is a cambered cover body.

Preferably, the optical device with the flowing effect further includes an interferometer plate; and the interferometer plate is located between the first cover body and the second cover body, or is arranged between the light bead and the first cover body.

Preferably, the second cover body is a sheetlike cover body; and a condensing lens is arranged on an upper side or a lower side of the second cover body.

Compared with the prior art, the present disclosure has the following advantages.

During use of the present disclosure, the positions of both the light bead and the driving mechanism are fixed through the stand body, so that light emitted by the light bead is projected to the outside from the first internal space of the first cover body via the second cover body. In the process that the driving mechanism drives the first cover body and the second cover body to undergo relative motion, since the textures are provided on the surfaces of both the first cover body and the second cover body, the light emitted by the light bead will distort and/or deform in the process of passing through the first cover body and the second cover body. Furthermore, with the relative motion between the two lamp covers, an optical path will move to change all the time. The optical path distorts and/or deforms after passing through the first cover body, and will distort and/or deform again when passing through the second cover body. Under the superposition and cooperation of the two optical path changes and the relative motion between the two lamp covers, the optical path can be completely dispersed, and projected light shadows have a flowing effect. The light shadows flow like water waves, and the lighting effect is soft and realistic.

### BRIEF DESCRIPTION OF THE DRAWINGS

To describe the technical solutions in the embodiments of the present disclosure or in the prior art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of Embodiment 1 of the present disclosure.

FIG. 2 is a schematic structural diagram of a first cover body being olive-shaped in the present disclosure.

FIG. 3 is a schematic structural diagram of a first cover body being drum-shaped in the present disclosure.

FIG. 4 is a schematic structural diagram of a first cover body being steplike in the present disclosure.

FIG. 5 is a schematic structural diagram of a first cover body being spherical in the present disclosure.

FIG. 6 is a schematic structural diagram of Embodiment II of a driving mode in the present disclosure.

FIG. 7 is a schematic structural diagram of Embodiment III of a driving mode in the present disclosure.

FIG. 8 is a schematic structural diagram of Embodiment 2 of the present disclosure.

FIG. 9 is a schematic structural diagram of Embodiment 3 of the present disclosure.

FIG. 10 is a schematic structural diagram of Embodiment 4 of the present disclosure.

FIG. 11 is a schematic structural diagram of Embodiment 5 of the present disclosure.

FIG. 12 is a schematic structural diagram of Embodiment 6 of the present disclosure.

FIG. 13 is a schematic structural diagram of Embodiment 7 of the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

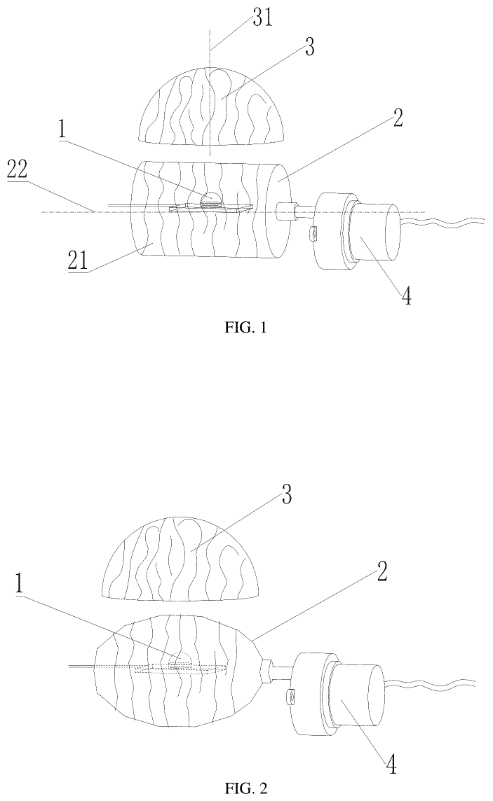

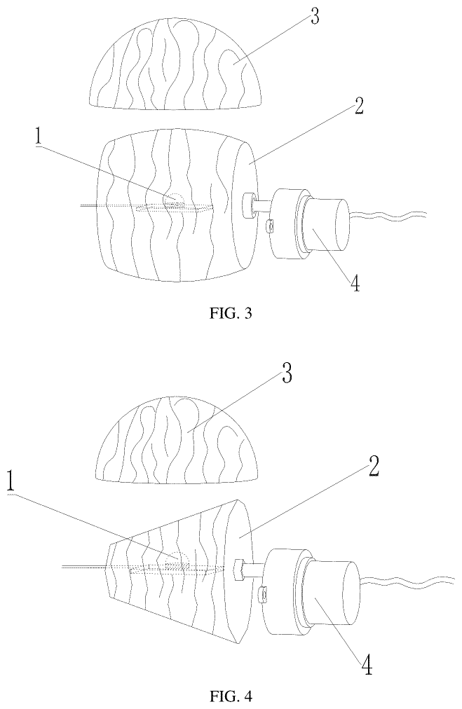

Referring to FIG. 1 to FIG. 13, an implementation of the present disclosure discloses an optical device with a flowing effect, including a light bead 1: a first cover body 2, having a first internal space 21, wherein the light bead 1 is located in the first internal space 21: a second cover body 3, located outside the first cover body 2, wherein textures are provided on surfaces of both the first cover body 2 and the second cover body 3: a driving mechanism 4, wherein the first cover body 2 and the second cover body 3 undergo relative motion under the driving of the driving mechanism 4; and a stand body, wherein the light bead 1 and the driving mechanism 4 are both fixed on the stand body.

Specifically, the stand body further includes a fixing plate. The light bead 1 is fixed at a position in the first internal space 21 through the fixing plate.

During use of the present disclosure, the positions of both the light bead 1 and the driving mechanism 4 are fixed through the stand body, so that light emitted by the light bead 1 is projected to the outside from the first internal space 21 of the first cover body 2 via the second cover body 3. In the process that the driving mechanism 4 drives the first cover body 2 and the second cover body 3 to undergo relative motion, since the textures are provided on the surfaces of both the first cover body 2 and the second cover body 3, the light emitted by the light bead 1 will distort and/or deform in the process of passing through the first cover body 2 and the second cover body 3. Furthermore, with the relative motion between the two lamp covers, an optical path will move to change all the time. The optical path distorts and/or deforms after passing through the first cover body 2, and will distort and/or deform again when passing through the second cover body 3. Under the superposition and cooperation of the two optical path changes and the relative motion between the two lamp covers, the optical path can be completely dispersed, and projected light shadows have a flowing effect. The light shadows flow like water waves, and the lighting effect is soft and realistic.

Referring to FIG. 2 to FIG. 5, specifically, the first cover body 2 can be in any of a cylindrical shape, a columnar shape, an olive shape, a drum shape, a cone shape, a step shape, and a spherical shape. When the first cover body 2 is in any of the cylindrical shape, the columnar shape, the olive shape, the drum shape, the cone shape, the step shape, and the spherical shape, the first cover body is ensured to have a stable internal space structure, namely, the first internal space 21. In conjunction with the structure where the textures are provided on the surface of the first cover body 2, when the light bead 1 is located in the first internal space 21, the light emitted by the light bead can be projected from the first cover body 2 after distorting and/or deforming.

Further, the relative motion between the first cover body 2 and the second cover body 3 is axial relative motion. It ensures that the light emitted by the light bead 1 can achieve a moving/flowing effect.

### Embodiment I

Referring to FIG. 1 to FIG. 5, the driving mechanism 4 is connected to the first cover body 2 and is configured to drive the first cover body 2 to perform rotation motion by using an axial horizontal line 22 as a rotation axis. Specifically, the driving mechanism 4 is a driving motor. An output end of the driving motor is connected to the first cover body 2 to drive the first cover body 2 to rotate.

In this structure, since the first cover body 2 has the first internal space 21. When the first cover body performs the rotation motion by using the axial horizontal line 22 as the rotation axis, and the light emitted by the light bead 1 is projected after passing through the first lamp cover that is rotating and is provided with the textures on the surface, the projected light moves all the time, to achieve a flowing lighting effect. When the light passes through the second cover body 3, the light emitted by the light bead 1 can be completely dispersed, so that the projected light shadows have a flowing effect.

### Embodiment II

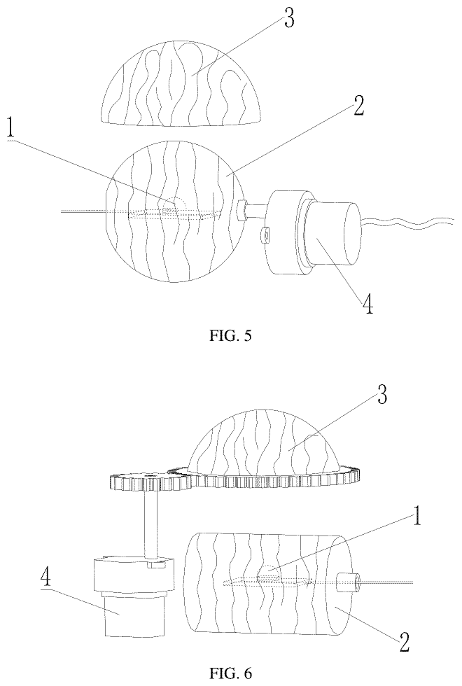

Referring to FIG. 6, the driving mechanism 4 is connected to the second cover body 3 and is configured to drive the second cover body 3 to perform rotation motion by using a vertical line 31, where a center line of the second cover body is located, as a rotation axis.

Specifically, at this time, the driving mechanism 4 includes a driving motor, a gear arranged on an output end of the driving motor, and a rack arranged on an outer circumference of a bottom of the second cover body 3 and meshed with the gear. Alternatively, the driving mechanism 4 includes a driving motor, a driving wheel arranged at an output end of the driving motor, a driven wheel arranged on an outer circumference of a bottom of the second cover body 3, and a conveyor belt. Both the driving wheel and the driven wheel are connected into the conveyor belt. When the motor drives the driving wheel to rotate, the driven wheel can be driven through the conveyor belt, thereby driving the second cover body 3 to perform the rotation motion.

In this structure, light emitted by the light bead 1 is projected out after distorting and/or deforming in the first lamp cover. When passing through the moving second lamp cover provided with the textures, the projected light is moving all the time, so that the light emitted by the light bead 1 can be completely dispersed, and the projected light shadows have a flowing effect.

### Embodiment III

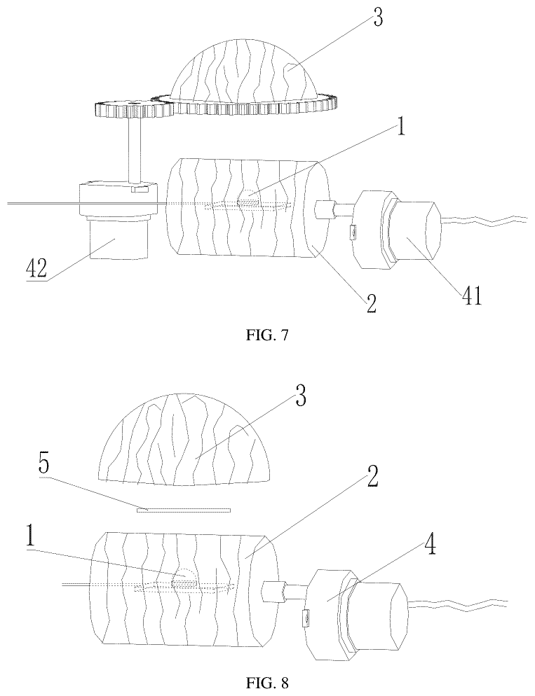

Referring to FIG. 7, further, the driving mechanism 4 includes a first driving structure 41 and a second driving structure 42: the first driving structure 41 is connected to the first cover body 2 and is configured to drive the first cover body 2 to perform rotation motion by using an axial horizontal line 22 as a rotation axis; and the second driving structure 42 is connected to the second cover body 3 and is configured to drive the second cover body 3 to perform rotation motion by using a vertical line 31, where a center line of the second cover body is located, as a rotation axis.

Specifically, the first driving structure 41 includes a first driving motor. An output end of the first driving motor is connected to the first cover body 2 and drives the first cover body 2 to rotate. The second driving structure 42 includes a second driving motor, a gear arranged on an output end of the first driving motor, and a rack arranged on an outer circumference of a bottom of the second cover body 3 and meshed with the gear. Alternatively, the second driving structure 42 includes a second driving motor, a driving wheel arranged at an output end of the second driving motor, a driven wheel arranged on an outer circumference of a bottom of the second cover body 3, and a conveyor belt. Both the driving wheel and the driven wheel are connected into the conveyor belt. When the second motor drives the driving wheel to rotate, the driven wheel can be driven through the conveyor belt, thereby driving the second cover body 3 to perform the rotation motion. This structure can ensure that both the first cover body 2 and the second cover body 3 perform the rotation motion by their respective rotation axes, and the first cover body 2 and the second cover body 3 perform relative motion. Therefore, the light in the light bead 1 is projected out in a moving form after distorting and/or deforming twice. The light emitted by the light bead 1 is dispersed, and the projected light shadows have a flowing effect.

### Embodiment IV

Referring to FIG. 1 to FIG. 7, further, the second cover body 3 is a cambered cover body.

The light bead 1 is used as a light emitting endpoint, and an angle range of light emission is about 100° to 140°. Therefore, after the light from the light bead 1 is projected from the first cover body 2 with the first internal space 21, the light is projected from the curved second cover body 3. Due to a larger surface area of the curved cover body, more light can be covered. Therefore, in this structure, the second cover body 3 can cover more light, so that as much light as possible can distort and/or deform and be projected when passing through the second cover body 3, thereby completely dispersing the light emitted by the light bead 1. The projected light shadows have a flowing effect.

Furthermore, the optical device further includes an interferometer plate 5. The interferometer plate 5 is located between the first cover body 2 and the second cover body 3, or between the light bead 1 and the first cover body 2.

### Embodiment V

Referring to FIG. 8, the interferometer plate 5 is located between the first cover body 2 and the second cover body 3, so that after the light bead 1 emits light, the light first distorts and/or deforms in the first cover body 2 and is projected. After the light is dispersed by the interferometer plate 5, the light then distorts and/or deforms in the second cover body 3 and is projected. Under the relative motion between the first cover body 2 and the second cover body 3, the finally projection effect is dynamic, making the viewing experience better.

### Embodiment VI

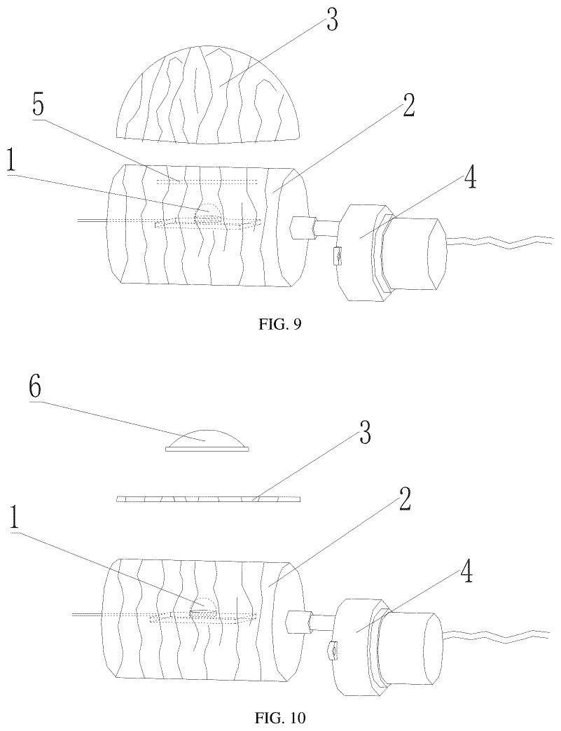

Referring to FIG. 9, the interferometer plate 5 is located between the light bead 1 and the first cover body 2. Specifically, the interferometer plate 5 and the light bead 1 are located together in the first internal space 21, so that after being dispersed by the interferometer plate 5 for the first time, the light distorts and/or deforms in the first cover body 2 and is then projected, and finally distorts and/or deforms in the second cover body 3 and is then projected. Under the relative motion between the first cover body 2 and the second cover body 3, the projected light shadows have a flowing effect.

Further, the second cover body 3 is a sheetlike cover body; and a condensing lens 6 is arranged on an upper side or a lower side of the second cover body 3.

### Embodiment VII

Referring to FIG. 10, the condensing lens 6 is located on the upper side of the second cover body 3. The condensing lens 6 is configured to converge the light emitted by the light bead 1. In this structure, the second cover body 3 is the sheet-like cover body, so after the light is emitted from the sheet-like cover body, the light can be converged in the condensing lens 6 and then dispersed and projected again, so that the light emitted by the light bead 1 can be completely dispersed and projected after passing through the two layers of lamp covers and the lens, and the projected light shadows also have a flowing effect.

### Embodiment VIII

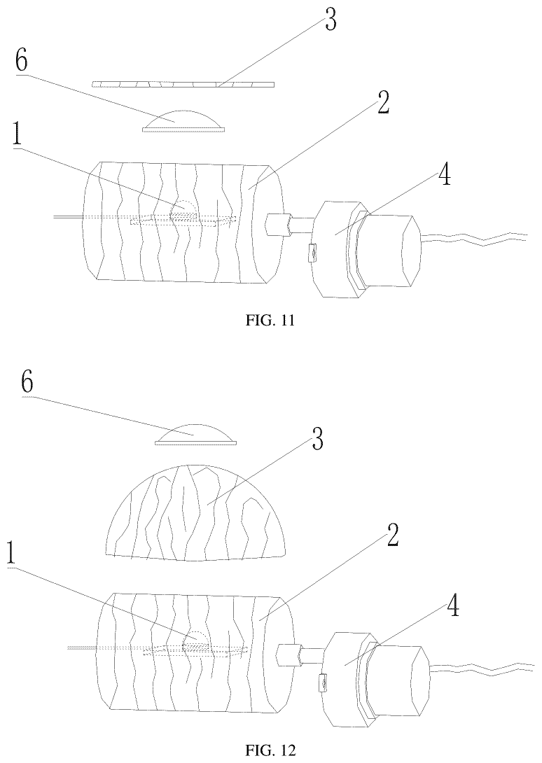

Referring to FIG. 11, the condensing lens 6 is arranged on the lower side of the second cover body 3. In this structure, the second cover body 3 is the sheet-like cover body. Therefore, after the light is emitted from the first cover body 2, the light can be converged in the condensing lens 6 and then dispersed and projected again. Then, the light is projected after distorting and/or deforming in the sheet-like cover body, so that the light emitted by the light bead 1 can be completely dispersed and projected after passing through the first lamp cover, the condensing lens 6, and second lamp cover in sequence, and the projected light shadows also have a flowing effect.

### Embodiment LX

Referring to FIG. 12, when the second cover body 3 is a cambered cover body, the condensing lens 6 is arranged on the upper side of the second cover body 3, so that the projected light shadows can achieve the same effect as the structure of Embodiment 4.

### Embodiment X

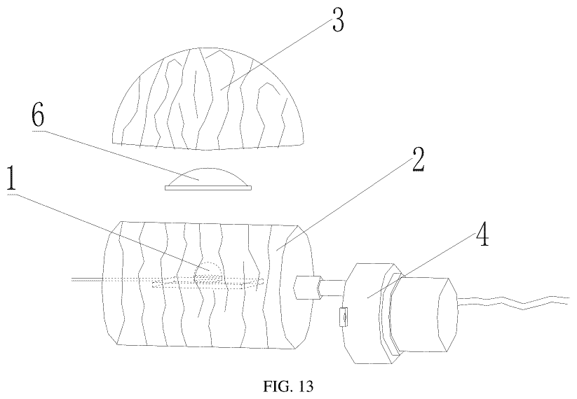

Referring to FIG. 13, when the second cover body 3 is a cambered cover body, the condensing lens 6 is arranged on the lower side of the second cover body 3, so that the projected light shadows can achieve the same effect as the structure of Embodiment 5.

The above describes the preferred embodiments of the present disclosure and is not intended to limit the present disclosure. Any modification, equivalent replacement, and improvement made within the spirit and scope of the present disclosure shall fall within the protection scope of the present disclosure.

1. An optical device with a flowing effect, comprising:
a light bead;
a first cover body, having a first internal space, wherein the light bead is located in the first internal space;
a second cover body, located outside the first cover body, wherein textures are provided on surfaces of both the first cover body and the second cover body;
a driving mechanism, wherein the first cover body and the second cover body undergo relative motion under the driving of the driving mechanism; and
a stand body, wherein the light bead and the driving mechanism are both fixed on the stand body.

2. The optical device with the flowing effect according to claim 1, wherein the first cover body is in any of a cylindrical shape, a columnar shape, an olive shape, a drum shape, a cone shape, a step shape, and a spherical shape.

3. The optical device with the flowing effect according to claim 1, wherein the relative motion is axial relative motion.

4. The optical device with the flowing effect according to claim 1, wherein the driving mechanism is connected to the first cover body and is configured to drive the first cover body to perform rotation motion by using an axial horizontal line as a rotation axis.

5. The optical device with the flowing effect according to claim 1, wherein the driving mechanism is connected to the second cover body and is configured to drive the second cover body to perform rotation motion by using a vertical line, where a center line of the second cover body is located, as a rotation axis.

6. The optical device with the flowing effect according to claim 1, wherein the driving mechanism comprises a first driving structure and a second driving structure; the first driving structure is connected to the first cover body and is configured to drive the first cover body to perform rotation motion by using an axial horizontal line as a rotation axis; and the second driving structure is connected to the second cover body and is configured to drive the second cover body to perform rotation motion by using a vertical line, where a center line of the second cover body is located, as a rotation axis.

7. The optical device with the flowing effect according to claim 1, wherein the second cover body is a cambered cover body.

8. The optical device with the flowing effect according to claim 1, further comprising an interferometer plate, wherein the interferometer plate is located between the first cover body and the second cover body, or is arranged between the light bead and the first cover body.

9. The optical device with the flowing effect according to claim 1, wherein the second cover body is a sheetlike cover body; and a condensing lens is arranged on an upper side or a lower side of the second cover body.
